(19) United States
(12) Patent Application Publication
(10) Pub. No.: US 2014/0161199 A1
(43) Pub. Date: Jun. 12, 2014

(54) METHOD AND APPARATUS FOR PROCESSING VIDEO IMAGE

(71) Applicant: Xiaomi Inc., Beijing (CN)

(72) Inventors: Xingsheng LIN, Beijing (CN); Xuanran Wang, Beijing (CN); Xiaojun Wu, Beijing (CN)

(73) Assignee: Xiaomi Inc., Beijing (CN)

(21) Appl. No.: 14/102,944

(22) Filed: Dec. 11, 2013

Related U.S. Application Data
(63) Continuation of application No. PCT/CN2013/078933, filed on Jul. 5, 2013.

(30) Foreign Application Priority Data
Dec. 6, 2012 (CN) 201210521773.5

(51) Int. Cl. H04N 19/89

(52) U.S. Cl. CPC H04N 19/00933
USPC 375/240.27

(57) ABSTRACT

A video image processing method for use in a terminal, including: detecting a packet loss rate in a current video image transmission; determining that the detected packet loss rate is higher than a predetermined threshold; and responsive to the determining, processing a first part of a video image corresponding to a target region based on a first code rate, and processing a second part of the video image corresponding to a non-target region based on a second code rate.

### CROSS REFERENCE TO RELATED APPLICATIONS

This application is a continuation of International Application No. PCT/CN2013/078933, filed Jul. 5, 2013, which is based upon and claims priority from Chinese Patent Application No. 201210521773.5, filed Dec. 6, 2012, the entire contents of which are incorporated herein by reference.

### TECHNICAL FIELD

The present disclosure relates generally to the technical field of communication and, more particularly, to a method and an apparatus for processing a video image.

### BACKGROUND

With rapid development of communication technologies, mobile phones have become necessities of most people's everyday work and life, and video communications on mobile phones is currently a popular communication manner.

Traditionally, video image compression coding is used in video communications. As is well known, a data size of digital video images is generally large. Without compression, the digital video images typically need to be transmitted at a high transmission rate and a storage with a huge capacity may be needed to store the digital video images. Thus, video image data is divided into a plurality of data packets for transmission via a network, and each data packet includes frames representing data information and providing data route. When the data packets are transmitted in a general medium, a small number of the data packets may be lost due to a distance between two terminals. A network packet loss rate is a ratio between the lost number of the data packets and a total number of the data packets. The network packet loss rate should be controlled within a certain range during a normal transmission.

In digital communications, a bandwidth resource may be limited. When a network environment is poor, the packet loss rate increases such that a video image displayed on a receiving terminal may be incomplete or unclear.

### SUMMARY

According to a first aspect of the present disclosure, there is provided a video image processing method for use in a terminal, comprising: detecting a packet loss rate in a current video image transmission; determining that the detected packet loss rate is higher than a predetermined threshold; and responsive to the determining, processing a first part of a video image corresponding to a target region based on a first code rate, and processing a second part of the video image corresponding to a non-target region based on a second code rate.

According to a second aspect of the present disclosure, there is provided a terminal, comprising: a processor; and a memory for storing instructions executable by the processor, wherein the processor is configured to: detect a packet loss rate in a current video image transmission; determine that the detected packet loss rate is higher than a predetermined threshold; and responsive to the determining, process a first part of a video image corresponding to a target region based on a first code rate, and process a second part of the video image corresponding to a non-target region based on a second code rate.

According to a third aspect of the present disclosure, there is provided a non-transitory medium including instructions, executable by a processor in a terminal, for performing a video image processing method, the method comprising: detecting a packet loss rate in a current video image transmission; determining that the detected packet loss rate is higher than a predetermined threshold; and responsive to the determining, processing a first part of a video image corresponding to a target region based on a first code rate, and processing a second part of the video image corresponding to a non-target region based on a second code rate.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for an apparatus to process a video image, according to an exemplary embodiment.

FIG. 2 is a flowchart of a method for an apparatus to process a video image, according to an exemplary embodiment.

FIG. 3 is a flowchart of a method for an apparatus to process a video image, according to an exemplary embodiment.

FIGS. 4A to 4C are diagrams illustrating determination of a target region, according to exemplary embodiments.

FIG. 5 is a flowchart of a method for an apparatus to process a target region and a non-target region on a video image based on first and second code rates, respectively, according to an exemplary embodiment.

FIG. 6 is a flowchart of a method for an apparatus to process a video image, according to an exemplary embodiment.

FIG. 7 is a block diagram of an apparatus for processing a video image, according to an exemplary embodiment.

FIG. 8 is a block diagram of a terminal, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

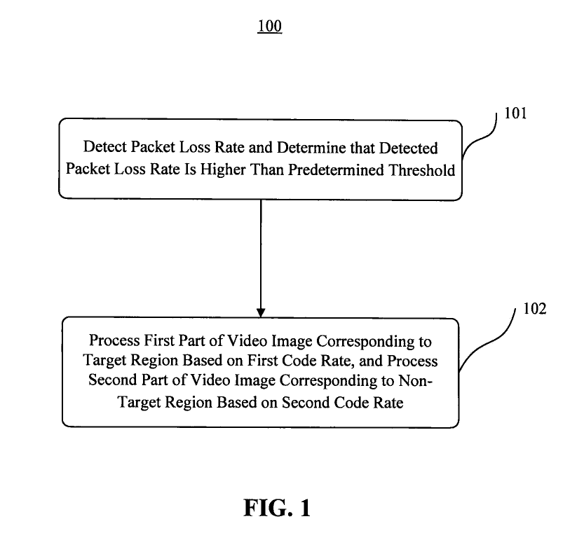

FIG. 1 is a flowchart of a method 100 for an apparatus, such as a mobile terminal, to process a video image, according to an exemplary embodiment. Referring to FIG. 1, in step 101, the apparatus detects a packet loss rate in a current transmission of a video image, and determines that the detected packet loss rate is higher than a predetermined threshold. In step 102, for a next transmission, the apparatus processes a first part of a video image corresponding to a predetermined target region based on a first code rate, and processes a second part of the video image corresponding to a non-target region based on a second code rate.

As used in the present disclosure, a code rate is a number of bits of data transmitted per time unit during data transmission, such as one kilobit per second (kbps). The code rate is directly proportional to quality and a file size of a transmitted video image.

In exemplary embodiments, the apparatus captures video images by a camera in the apparatus. Alternatively, video images may be locally saved in the apparatus, or may be obtained by downloading from a server.

In exemplary embodiments, the apparatus transmits the video image in the current transmission at a default code rate, which is not higher than a larger one of the first and second code rates and is higher than a smaller one of the first and second code rates. Accordingly, the apparatus detects the packet loss rate in the current transmission at the default code rate. In one exemplary embodiment, the target region is an important region to be highlighted. To ensure clarity of the first part of the video image corresponding to the target region when resources, such as network bandwidth, are limited, the apparatus may use a decreased code rate for the second part of the video image corresponding to the non-target region. Further, the apparatus may use an increased code rate for first part of the video image corresponding to the target region. Accordingly, the first code rate is provided to be higher than the second code rate, and the default code rate is not higher than the first code rate and is higher than the second code rate. In one exemplary embodiment, the non-target region is an important region to be highlighted. Accordingly, the second code rate is provided to be higher than the first code rate, and the default code rate is not higher than the second code rate and is higher than the first code rate.

In exemplary embodiments, in the current transmission, the apparatus divides the video image into a first part corresponding to the target region and a second part corresponding to the non-target region, and separately transmits the first part and the second part on first and second communication channels, respectively. In this case, the apparatus detects first and second packet loss rates on the first and second communication channels, respectively, and calculates an average value of the detected first and second packet loss rates as the packet loss rate in the current transmission. In one exemplary embodiment, the apparatus uses a same code rate to transmit the first part and the second part of the video image in the current transmission. Accordingly, the apparatus uses the packet loss rate detected on either of the first and second communication channels as the packet loss rate in the current transmission.

In exemplary embodiments, the apparatus determines a position and a size of the target region on a video image based on inputted configuration parameters, default configuration parameters, or self-adaptive algorithms, and any region that is not determined to be a target region is considered as a non-target region. For example, the apparatus determines the position and the size of the target region based on a shape formed by the user's sliding on a touch screen of the apparatus. Also for example, the apparatus determines the position and the size of the target region based on a default origin and a default radius preset in the apparatus. Further for example, the apparatus determines the position and the size of the target region based on a self-adaptive algorithm, such as a human face recognition technology.

In exemplary embodiments, the apparatus obtains a predetermined code rate from, e.g., its memory, as the first code rate, and processes a first part of a video image corresponding to the target region based on the first code rate. The apparatus further decreases an initial code rate used for the non-target region. If the apparatus determines that the detected packet loss rate in a transmission of that video image is not higher than the predetermined threshold, the apparatus determines the decreased code rate as the second code rate, and processes the video image for the next transmission by using the second code rate for the non-target region.

In exemplary embodiments, after processing the first part and the second part of the video image for the next transmission, the apparatus synthesizes the processed first part corresponding to the target region and the processed second part corresponding to the non-target region to generate a synthesized video image. The apparatus further transmits the synthesized video image to another terminal for display. Alternatively, the apparatus directly transmits to the other terminal the processed first part corresponding to the target region and the processed second part corresponding to the non-target region, which are synthesized at the other terminal for display.

In the above exemplary embodiments, the apparatus divides a video image into a first part corresponding to the target region and a second part corresponding to the non-target region, and uses different code rates for the different parts of the video image. Accordingly, when resources, such as network bandwidth, are limited, clarity of the first part of the video image corresponding to the target region can be ensured preferentially to meet requirements. As a result, the effect of fluent video communication may be achieved. Meanwhile, a lower code rate is used for the relatively unimportant, non-target region, so as to decrease the packet loss rate.

In exemplary embodiments, the apparatus divides each video image into a first part corresponding to the target region and a second part corresponding to the non-target region before it determines that the detected packet loss rate is higher than the predetermined threshold, and establishes first and second communication channels for the first and second parts, respectively, through software programs. Alternatively, the apparatus can distinguish the target region from the non-target region in the video image when the apparatus determines that the detected packet loss rate in the current transmission is higher than the predetermined threshold. In addition, a number of target regions and a number of non-target regions may each be more than one.

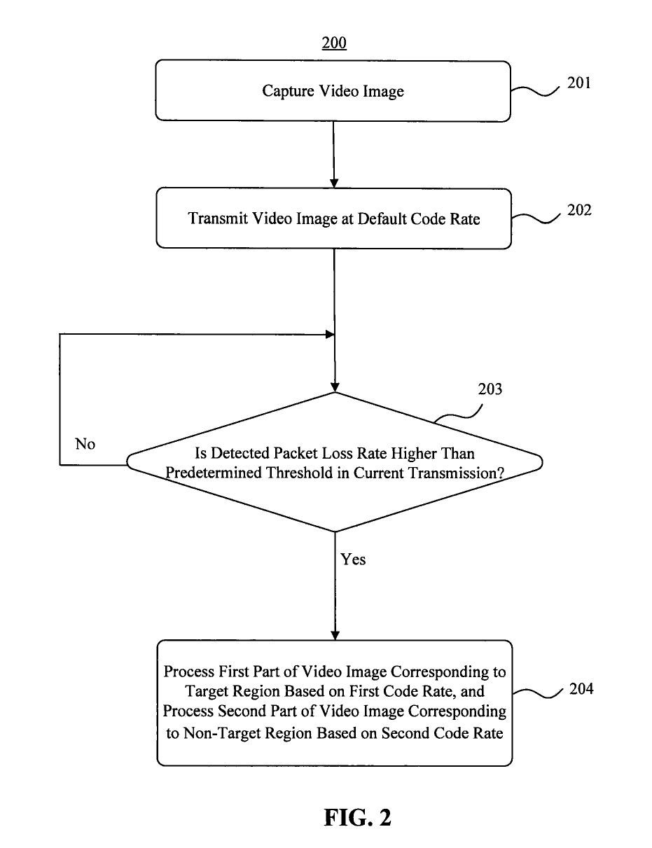

FIG. 2 is a flowchart of a method 200 for the apparatus to process a video image, according to an exemplary embodiment. In the method 200, the apparatus distinguishes a target region from a non-target region in a video image when the apparatus determines that the detected packet loss rate in a current transmission is higher than the predetermined threshold.

Referring to FIG. 2, in step 201, the apparatus captures a video image by its camera. For example, when the user uses the apparatus to conduct a video call, after the user starts the video call, the apparatus activates the camera to capture the video image.

In step 202, the apparatus transmits the video image at a default code rate.

In step 203, the apparatus detects a packet loss rate in the current transmission at the default code rate. If the apparatus determines that the detected packet loss rate is higher than the predetermined threshold, the apparatus performs step 204; otherwise, the apparatus continues the detecting.

In step 204, the apparatus processes a video image for a next transmission according to the target region and the non-target region. For example, the apparatus processes a first part of the video image corresponding to the target region based on a first code rate, and processes a second part of the video image corresponding to the non-target region based on a second code rate. The default code rate is not higher than a larger one of the first and second code rates and is higher than a smaller one of the first and second code rates. That is, in the next transmission, the code rate for the first part of the video image corresponding to the target region is increased compared to the default code rate, so as to ensure high quality and clarity of the first part of the video image corresponding to the target region. Meanwhile, because of limitations on network environments such as network bandwidth, the code rate for the second part of the video image corresponding to the non-target region is decreased compared to the default code rate, by, e.g., performing image blurring.

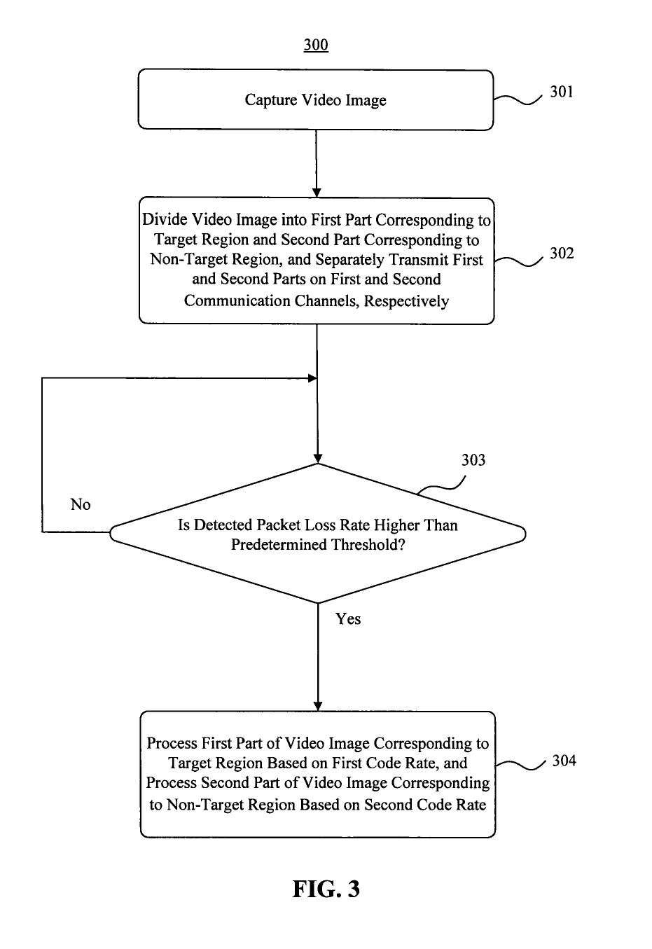

FIG. 3 is a flowchart of a method 300 for the apparatus to process a video image, according to an exemplary embodiment. In the method 300, the apparatus divides each video image into a first part corresponding to a target region and a second part corresponding to a non-target region before it determines that the detected packet loss rate is higher than the predetermined threshold, and establishes first and second communication channels for the first part and the second part, respectively, through software programs.

Referring to FIG. 3, in step 301, the apparatus captures a video image by its camera. For example, when the user uses the apparatus to conduct a video call, after the user starts the video call, the apparatus activates the camera to capture the video image.

In step 302, the apparatus divides the video image into a first part corresponding to the target region and a second part corresponding to the non-target region, and separately transmits the first part and the second part on the first and second communication channels, respectively.

In step 303, the apparatus detects a packet loss rate in a current transmission. For example, the apparatus detects first and second packet loss rates on the first and second communication channels, respectively, and calculates an average value of the detected first and second packet loss rates as the packet loss rate in the current transmission. Also for example, if the code rates used for the target region and the non-target region are the same in the current transmission, the apparatus detects the packet loss rate on either of the first and second communication channels as the packet loss rate in the current transmission. If the apparatus determines that the detected packet loss rate is higher than the predetermined threshold, the apparatus performs step 304; otherwise, the apparatus continues the detecting.

In step 304, the apparatus processes a video image for a next transmission. For example, the apparatus processes a first part of the video image corresponding to the target region based on a first code rate, and processes a second part of the video image corresponding to the non-target region based on a second code rate. The code rate for the target region in the next transmission is increased compared to the code rate for the target region in the current transmission, so as to ensure high quality and clarity of the first part of the video image corresponding to the target region in the next transmission. Meanwhile, because of limitations on network environments such as network bandwidth, the code rate for the non-target region in the next transmission is decreased compared to the code rate for the non-target region in the current transmission, by performing image blurring.

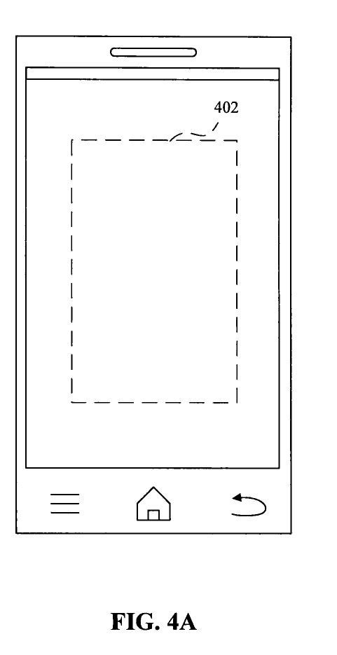

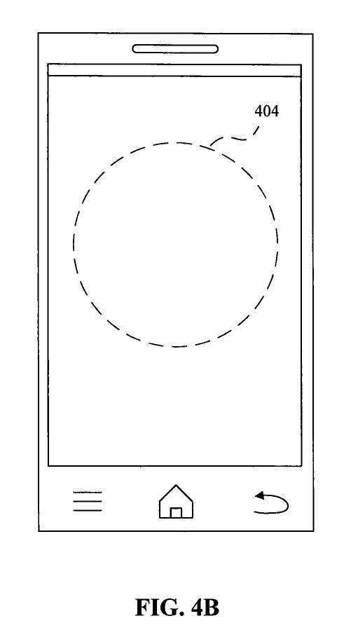

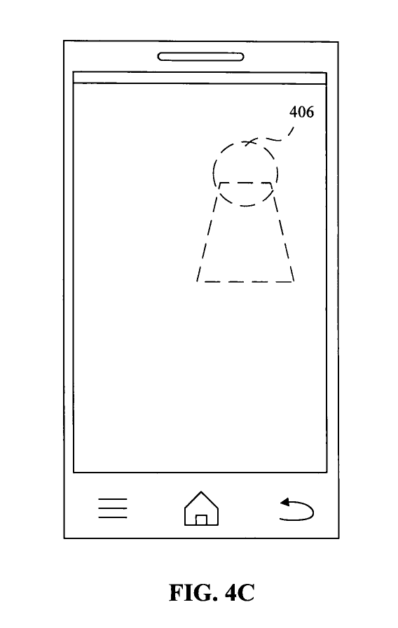

In the above described embodiments, the apparatus determines a position and a size of the target region based on inputted configuration parameters, default configuration parameters, or self-adaptive algorithms. As shown in FIG. 4A, the user's sliding on the touch screen of the apparatus forms a rectangle region 402, indicated by the dotted line in FIG. 4A, then the apparatus can determine that the rectangle region 402 as the target region. As shown in FIG. 4B, default configuration parameters, such as an origin and a radius of a circular region 404, indicated by the dotted line in FIG. 4B, may be preset, and the apparatus uses the circular region 404 as the target region. As shown in FIG. 4C, using a self-adaptive algorithm, the apparatus can recognize a human face region 406 based on a human face recognition technology, and determines the region 406 as the target region.

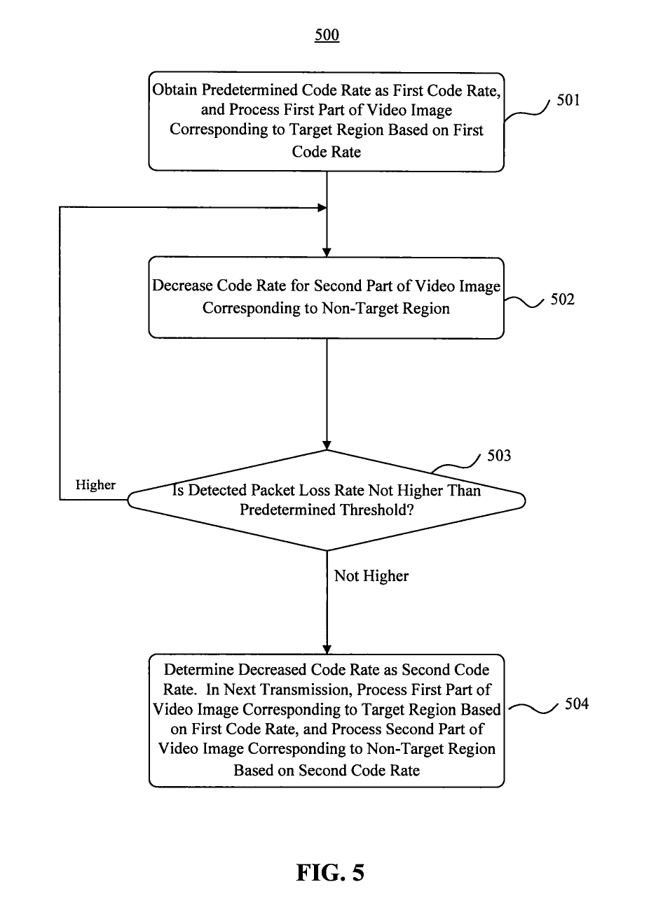

FIG. 5 is a flowchart of a method 500 for the apparatus to process a target region and a non-target region on a video image based on first and second code rates, respectively, according to an exemplary embodiment. For example, step 204 in FIG. 2 and step 304 in FIG. 3 may be based on the method 500.

Referring to FIG. 5, in step 501, the apparatus obtains a predetermined code rate from, e.g., its memory, as the first code rate. The apparatus processes a first part of a video image corresponding to the target region based on the first code rate. In the illustrated embodiment, to ensure clarity for the target region, the first code rate is preset. When video image transmission needs to be adjusted, e.g., when the packet loss rate is too large, the first code rate may be obtained directly, and the first part of the video image corresponding to the target region may be processed based on the first code rate.

In step 502, the apparatus decreases an initial code rate, e.g., the default code rate, used for the non-target region. In the illustrate embodiment, because resources, such as network bandwidth, are limited, to ensure clarity of a first part of the video image corresponding to the target region, the code rate for the non-target region may be decreased by performing image blurring, so as to reduce the resource occupied by a second part of the video image. Since the second part of the video image corresponding to the non-target region generally is unimportant information determined by the user, viewing of the video image will not be affected. The apparatus then processes the second part of the video image based on the decreased code rate.

In step 503, the apparatus detects a packet loss rate in a current transmission. If the apparatus determines that the detected packet loss rate is not higher than the predetermined threshold, the apparatus performs step 504; otherwise, the apparatus performs step 502.

In step 504, the apparatus determines the decreased code rate as the second code rate. In a next transmission, the apparatus processes a first part of a video image corresponding to the target region based on the first code rate, and processes a second part of the video image corresponding to the non-target region based on the second code rate.

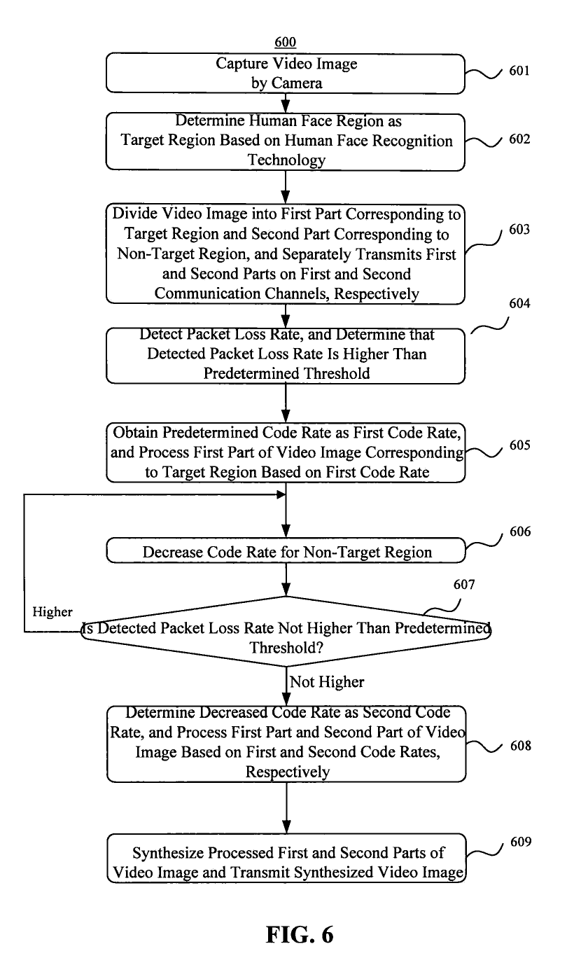

FIG. 6 is a flowchart of a method 600 for the apparatus to process a video image, according to an exemplary embodiment.

Referring to FIG. 6, in step 601, the apparatus captures a video image by its camera.

In step 602, the apparatus determines a human face region as a target region based on a human face recognition technology.

In step 603, the apparatus divides the video image into a first part corresponding to the target region and a second part corresponding to the non-target region, and separately transmits the first and second parts on first and second communication channels, respectively, for example, using a same code rate.

In step 604, the apparatus detects a packet loss rate on either of the first and second communication channels as the packet loss rate in the current transmission, and determines that the detected packet loss rate is higher than the predetermined threshold.

In step 605, the apparatus obtains a predetermined code rate as a first code rate. The apparatus processes a first part of a video image corresponding to the target region based on the first code rate in a next transmission.

In step 606, the apparatus decreases the code rate for the non-target region in the next transmission.

In step 607, the apparatus detects a packet loss rate in the next transmission. If the apparatus determines that the detected packet loss rate is not higher than the predetermined threshold, the apparatus performs step 608; otherwise, the apparatus repeats step 606.

In step 608, the apparatus determines the decreased code rate as a second code rate, and processes a video image in a next transmission. For example, the apparatus processes a first part of the video image corresponding to the target region based on the first code rate, and processes a second part of video image corresponding to the non-target region based on the second code rate.

In step 609, the apparatus synthesizes the processed first part of the video image corresponding to the target region and the processed second part of the video image corresponding to the non-target region, and transmits the synthesized video image for another terminal to display.

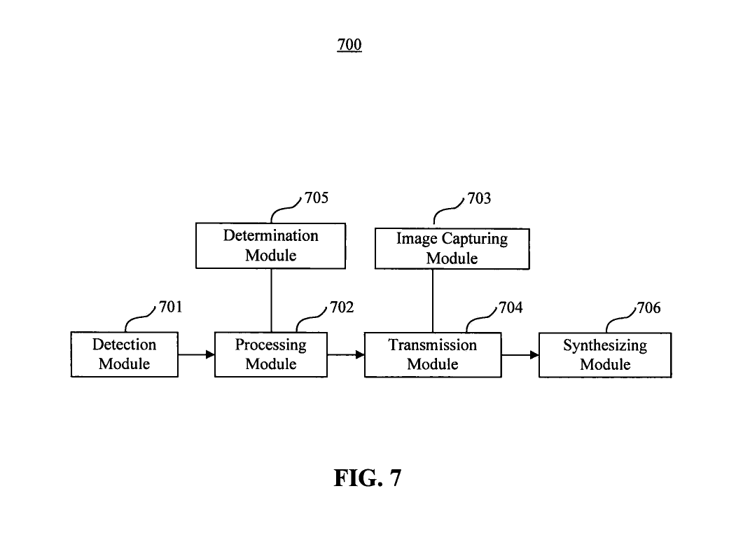

FIG. 7 illustrates a block diagram of an apparatus 700 for processing a video image, according to an exemplary embodiment. For example, the apparatus 700 may be a mobile terminal configured to process a video image in a short message to be sent.

Referring to FIG. 7, the apparatus 700 includes a detection module 701 and a processing module 702, In exemplary embodiments, the detection module 701 is configured to detect a packet loss rate in a current transmission of a video image, and the processing module 702 is configured to, if it determines that the detected packet loss rate is higher than a predetermined threshold, process a video image in a next transmission by processing a first part of the video image corresponding to a target region based on a first code rate, and processing a second part of the video image corresponding to a non-target region based on a second code rate.

In exemplary embodiments, the apparatus 700 may further include an image capturing module 703 configured to capture video images. The image capturing module 703 may be a camera.

In exemplary embodiments, the apparatus 700 may further include a transmission module 704 configured to transmit the video image in the current transmission at a default code rate, which is not higher than a larger one of the first code rate and the second code rate and is higher than a smaller one of the first code rate and the second code rate. The transmission module 704 is also configured to divide the video image in the current transmission into a first part corresponding to the target region and a second part corresponding to the non-target region, and separately transmit the first part and the second part on first and second communication channels, respectively.

In one exemplary embodiment, when the transmission module 704 transmits the video image at the default code rate in the current transmission, the detection module 701 detects the packet loss rate of the transmitted video image.

In one exemplary embodiment, when the transmission module 704 divides the video image into the first part corresponding to the target region and the second part corresponding to the non-target region, and separately transmits them on the first and second communication channels in the current transmission, the detection module 701 detects first and second packet loss rates on the first and second communication channels, respectively, and calculates an average value of the detected first and second packet loss rates as the packet loss rate in the current transmission. If the code rates used for the target region and the non-target region are the same in the current transmission, the detection module 701 detects the packet loss rate on either of the first and second communication channels as the packet loss rate in the current transmission.

In exemplary embodiments, the apparatus 700 may further include a determination module 705 configured to determine a position and a size of the target region based on inputted configuration parameters, default configuration parameters, or self-adaptive algorithms.

In exemplary embodiments, the processing module 702 is also configured to obtain a predetermined code rate as the first code rate and process a first part of a video image corresponding to the target region based on the first code rate. The processing module 702 further decreases an initial code rate, e.g., the default code rate, used for the non-target region, and processes a second part of that video image corresponding to the target region based on the decreased code rate. If it is determined that the detected packet loss rate in the transmission of that video image is not higher than the predetermined threshold, the processing module 702 determines the decreased code rate as the second code rate, and processes a video image in a next transmission based on the first and second code rates. For example, the processing module 702 processes a first part of the image corresponding to the target region based on the first code rate, and processes a second part of the video image corresponding to the non-target region based on the second code rate.

In exemplary embodiments, the apparatus 700 may further include a synthesizing module 706 configured to synthesize the processed first part of the video image corresponding to the target region and the processed second part of the video image corresponding to the non-target region.

One of ordinary skill in the art would understand that the above described modules can each be implemented by hardware, or software, a combination of hardware and software. One of ordinary skill in the art would also understand that the above described modules may be distributed in the apparatus of the embodiment, or may be correspondingly varied to be positioned in one or more apparatuses other than that of the embodiment. Multiple ones of the above described modules may be combined as one module, and each of the above described modules may be further divided into a plurality of sub-modules.

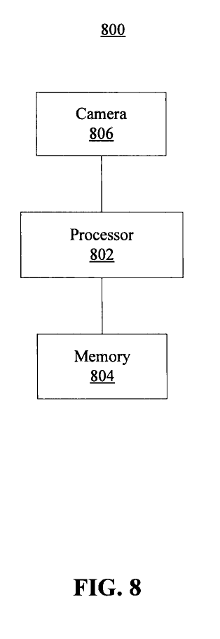

FIG. 8 illustrates a block diagram of a terminal 800, according to an exemplary embodiment. For example, the terminal 800 may be a mobile terminal. Referring to FIG. 8, the terminal 800 includes a processor 802 configured to execute computer program instructions to perform the above described video image processing methods, a memory 804 for storing information, and a camera 806 to capture video images.

In exemplary embodiments, there is also provided a non-volatile readable storage medium including instructions, such as included in the memory 804, executable by the processor 802 in the terminal 800, for performing the above-described video image processing methods.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A video image processing method for use in a terminal, comprising:
detecting a packet loss rate in a current video image transmission;
determining that the detected packet loss rate is higher than a predetermined threshold; and
responsive to the determining, processing a first part of a video image corresponding to a target region based on a first code rate, and processing a second part of the video image corresponding to a non-target region based on a second code rate.

2. The method according to claim 1, further comprising:
capturing the video image by a camera.

3. The method according to claim 1, wherein the current video image transmission includes transmission of a first video image, the detecting of the packet loss rate comprising:
transmitting the first video image at a default code rate, the default code rate being not higher than a larger one of the first code rate and the second code rate and higher than a smaller one of the first code rate and the second code rate; and
detecting the packet loss rate when the first video image is transmitted at the default code rate.

4. The method according to claim 1, wherein the current video image transmission includes transmission of a first video image, the method further comprising:
dividing the first video image into a first part corresponding to the target region and a second part corresponding to the non-target region;
separately transmitting the first part and the second part of the first video image on first and second communication channels, respectively;
detecting first and second packet loss rates on the first and second communication channels, respectively; and
calculating an average value of the detected first and second packet loss rates as the detected packet loss rate for the current video image transmission.

5. The method according to claim 1, wherein the current video image transmission includes transmission of a first video image, the method further comprising:
dividing the first video image into a first part corresponding to the target region and a second part corresponding to the non-target region;
separately transmitting the first part and the second part of the first video image on first and second communication channels, respectively, using a same code rate; and
detecting a packet loss rate on either of the first and second communication channels as the detected packet loss rate in the current video image transmission.

6. The method according to claim 1, further comprising:
determining a position and a size of the target region for the video image based on at least one of an inputted configuration parameter, a default configuration parameter, or a self-adaptive algorithm.

7. The method according to claim 1, further comprising:
obtaining a predetermined code rate as the first code rate;
processing a first part of a first video image corresponding to the target region based on the first code rate;
decreasing an initial code rate used for the non-target region, and processing a second part of the first video image corresponding to the non-target region based on the decreased code rate;
detecting a packet loss rate in a transmission of the first video image, and determining that the detected packet loss rate in that transmission is not higher than the predetermined threshold; and
determining the decreased code rate as the second code rate.

8. The method according to claim 1, further comprising:
synthesizing the processed first part of the video image corresponding to the target region and the processed second part of the video image corresponding to the non-target region to generate a synthesized video image, and
transmitting the synthesized video image.

9. The method according to claim 1, further comprising:
directly transmitting the processed first part of the video image corresponding to the target region and the processed second part of the video image corresponding to the non-target region.

10. A terminal, comprising:
a processor; and
a memory for storing instructions executable by the processor,
wherein the processor is configured to:
detect a packet loss rate in a current video image transmission;
determine that the detected packet loss rate is higher than a predetermined threshold; and
responsive to the determining, process a first part of a video image corresponding to a target region based on a first code rate, and process a second part of the video image corresponding to a non-target region based on a second code rate.

11. The terminal according to claim 10, further comprising:
a camera for capturing the video image.

12. The terminal according to claim 10, wherein the current video image transmission includes transmission of a first video image, the processor being further configured to:
transmit the first video image at a default code rate, the default code rate being not higher than a larger one of the first code rate and the second code rate and being higher than a smaller one of the first code rate and the second code rate; and
detect the packet loss rate when the first video image is transmitted at the default code rate.

13. The terminal according to claim 10, wherein the current video image transmission includes transmission of a first video image, the processor being further configured to:
divide the first video image into a first part corresponding to the target region and a second part corresponding to the non-target region;
separately transmit the first part and the second part of the first video image on first and second communication channels, respectively;
detect first and second packet loss rates on the first and second communication channels, respectively; and
calculate an average value of the detected first and second packet loss rates as the detected packet loss rate for the current video image transmission.

14. The terminal according to claim 10, wherein the current video image transmission includes transmission of a first video image, the processor being further configured to:
divide the first video image into a first part corresponding to the target region and a second part corresponding to the non-target region;
separately transmit the first part and the second part of the first video image on first and second communication channels, respectively, using a same code rate; and
detect a packet loss rate on either of the first and second communication channels as the detected packet loss rate in the current video image transmission.

15. The terminal according to claim 10, wherein the processor is further configured to:
determine a position and a size of the target region for the video image based on at least one of an inputted configuration parameter, a default configuration parameter, or a self-adaptive algorithm.

16. The terminal according to claim 10, wherein the processor is further configured to:
obtain a predetermined code rate as the first code rate;
process a first part of a first video image corresponding to the target region based on the first code rate;
decrease an initial code rate used for the non-target region, and process a second part of the first video image corresponding to the non-target region based on the decreased code rate;
detect a packet loss rate in a transmission of the first video image, and determine that the detected packet loss rate in that transmission is not higher than the predetermined threshold; and
determine the decreased code rate as the second code rate.

17. The terminal according to claim 10, wherein the processor is further configured to:
synthesize the processed first part of the video image corresponding to the target region and the processed second part of the video image corresponding to the non-target region to generate a synthesized video image; and
transmit the synthesized video image.

18. The terminal according to claim 10, wherein the processor is further configured to:
directly transmit the processed first part of the video image corresponding to the target region and the processed second part of the video image corresponding to the non-target region.

19. A non-transitory medium including instructions, executable by a processor in a terminal, for performing a video image processing method, the method comprising:
detecting a packet loss rate in a current video image transmission;
determining that the detected packet loss rate is higher than a predetermined threshold; and
responsive to the determining, processing a first part of a video image corresponding to a target region based on a first code rate, and processing a second part of the video image corresponding to a non-target region based on a second code rate.

20. The non-transitory medium according to claim 19, wherein the current video image transmission includes transmission of a first video image, the method further comprising:
dividing the first video image into a first part corresponding to the target region and a second part corresponding to the non-target region;
separately transmitting the first part and the second part of the first video image on first and second communication channels, respectively;
detecting first and second packet loss rates on the first and second communication channels, respectively; and
calculating an average value of the detected first and second packet loss rates as the detected packet loss rate for the current video image transmission.
